(19) United States
(12) Patent Application Publication
(10) Pub. No.: US 2011/0246383 A1
(43) Pub. Date: Oct. 6, 2011

(54) SUMMARY PRESENTATION OF MEDIA CONSUMPTION

(75) Inventors: Chad Gibson, Seattle, WA (US); Arjun Dayal, Redmond, WA (US)

(73) Assignee: MICROSOFT CORPORATION, Redmond, WA (US)

(21) Appl. No.: 12/750,226

(22) Filed: Mar. 30, 2010

(51) Int. Cl. G06F 17/30; G06Q 99/00

(52) U.S. Cl. 705/319; 707/740; 707/734; 707/E17.032; 707/E17.109

(57) ABSTRACT

Summary presentation of media consumption is described herein. An exemplary method for generating a personal highlight reel includes receiving personal consumption data indicating one or more media units consumed by a user computing device, and storing the personal consumption data in association with a user identifier. The method further includes identifying one or more relevant personal media units based on the personal consumption data. The method further includes generating a personal highlight reel including one or more personal media events representative of the one or more relevant personal media units, and outputting the personal highlight reel.

### BACKGROUND

Social discovery of media is a powerful tool for discovering new media, including television shows, movies, music, podcasts, and numerous other types of media. However, social discovery of media typically involves receiving recommendations from a friend, or actively pursuing discovery of new media by manually filtering through a friend's media consumption history. Unfortunately, this can result in a user receiving unwelcome or too-frequent recommendations, and manually filtering a friend's media consumption history can be cumbersome and time-consuming.

### SUMMARY

Summary presentation of media consumption is described herein. According to one aspect of the disclosure, a highlight reel is used to summarize media consumption of one or more users. A highlight reel may include media events representative of media units consumed by a user computing device, such that a user can review previously consumed media. In other examples, a highlight reel may include media events representative of one or more media units consumed by one or more friend computing devices, such that a user can review media previously consumed by one or more friends

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic view of an example system for communicating consumption data.

FIG. 2 is a schematic view of an example system for generating highlight reels.

FIG. 3 is a flowchart illustrating an example method for generating a personal highlight reel.

FIG. 4 schematically shows example user interfaces for presenting a personal highlight reel.

FIG. 5 is a flowchart illustrating an example method for generating a community highlight reel.

FIG. 6 is a flowchart illustrating an example method for generating a targeted friend highlight reel.

FIG. 7 schematically shows example user interfaces for presenting a targeted friend highlight reel.

### DETAILED DESCRIPTION

In order to assist a user of a media service in planning future media consumption, systems and methods described herein allow a user to review previously consumed media in the form of a personal highlight reel. For example, a television service may provide a user with a video highlight reel including video clips from television shows, videos, video games, and other video material consumed by the user. As an alternate example, a music service may provide a user with an audio highlight reel of music, podcasts, audio books, and other audio material consumed by the user. In other examples, a service may be able to track both television and music consumption. Moreover, a highlight reel may include other types of information in any format. For example, highlights of video game play including a level accomplished, or achievements granted may be included in a highlight reel. As will be discussed later, a personal highlight reel can be shared with the user's friends to let the user's friends know what the user has been consuming.

For example, a personal highlight reel might include a series of video clips representative of television shows, movies, video games, music, podcasts, and/or any other consumable media that the user has watched, listened to, or otherwise consumed lately. One nonlimiting example of a personal highlight reel might include four different 20 second clips, where each 20 second clip represents a television show the user has viewed frequently in the last week (e.g., top four most-viewed television shows). In another nonlimiting example, a personal highlight reel might include a 20 second clip of the user's favorite TV show, a 30 second trailer for a movie the user watched, and a 10 second clip of the user's most-listened-to song. Furthermore, a media service that includes a social networking component may be able to share the personal highlight reel not only with the user, but also with the user's friends, or other users of the media service.

In another example, a media service may provide a user with an opportunity to review a summarized history of a social community's media consumption, in the form of a community highlight reel. A social community may be the entire set of a user's friends, or a subset of the user's friends (e.g., friends with a common demographic characteristic). The community highlight reel may include community media events (e.g., video clips, audio clips, video game scenarios) that represent media units that are popular according to members of the social community. In one example, a community highlight reel might include the movies that have been recommended a highest number of times by all friends of a user. In this way, the user can quickly and easily view highlights of the entire social community's recent media consumption history.

Further still, a user may also be able to review a targeted friend highlight reel, for example, to assist a user in planning future media consumption. In one nonlimiting example, the user can specify one or more friends upon which the generation of the targeted friend highlight reel is to be based. For example, a user may have five close friends whose media tastes closely align with the user's media tastes. As such, the user may request, and subsequently receive, a targeted friend highlight reel based on only the media consumption history of the five close friends.

In other examples, any of a personal highlight reel, community highlight reel, or targeted friend highlight reel can be automatically generated and/or presented to a user. For example, a user may be automatically presented with a personal highlight reel upon turning on the user's television. In another example, upon a user's navigation to a friend's website, a targeted friend highlight reel based on consumption history of the friend may be automatically presented.

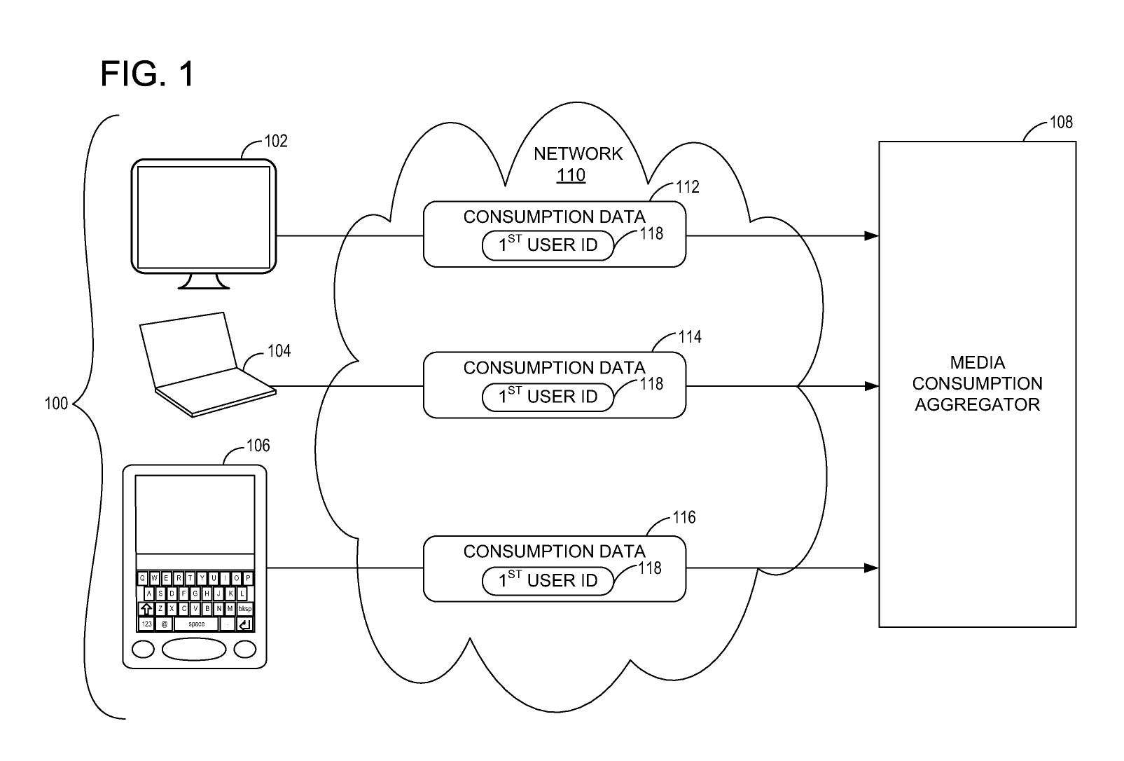

As shown in FIG. 1, a plurality of devices 100, including television 102, laptop 104, and mobile phone 106, may communicate with media consumption aggregator 108 via one or more networks, such as network 110. Although not shown, the media consumption aggregator 108 may optionally send media units (e.g., movies, TV shows, video games, podcasts, music, etc.) for consumption to one or more of the plurality of devices 100. However, in other cases, the media units consumed via one or more of the plurality of devices 100 may be received from a third party media provider (e.g., from a third party server via a network, from a removable media storage, etc.).

Media units are consumed via the television 102, the laptop 104, and the mobile phone 106 by a same user, in this example. As such, consumption data 112 from the television 102, consumption data 114 from the laptop 104, and consumption data 116 from the mobile phone 106 are associated with a same user identifier 118. To be clear, the user identifier 118 may include data representative of the user's identity. This may be any type of data or combination of data, such as an identification code, user name, or password, as just some examples.

In this example, consumption data received at the media consumption aggregator 108 from each of the plurality of devices 100 is associated with a same user identifier 118 by the respective devices reporting the consumption data. In other cases, a user identifier received from each of several devices may be derived from a user identity associated with a media provider (e.g., a third party media provider) providing media units to each of the plurality of devices 100. Thus, a user identifier received at the media consumption aggregator 108 may be different than an identifier that a media provider uses to represent a user when the media is originally consumed by the user. In some cases, this may be reconciled at the media consumption aggregator 108, where different user identifiers used by different parties are converted to a same user identifier.

In any case, the consumption data 112 from the television 102, the consumption data 114 from the laptop 104, and the consumption data 116 from the mobile phone 106 are aggregated and stored at the media consumption aggregator 108 in association with a same user identifier 118. In this way, consumption data regarding media units consumed in association with a user represented by user identifier 118 can be reliably tracked regardless of a source (e.g., media provider) of the consumed media units, or a device by which the user consumes media.

A second user may consume media via the television 102, laptop 104, and/or mobile phone 106. In order to ensure that media consumption by a first user is associated with a first user identifier and that media consumption by the second user is associated with a second user identifier, users of the media consumption aggregator 108 may be asked to provide a user log-in in order to consume media units and/or to track media consumption, as just one example. Alternately, users other than a primary, or default, user may be allowed to log in as a guest in order to consume media. By allowing the second user to log in as a guest, ensuing media consumption can be associated with a guest identifier, thereby avoiding an inappropriate association of the ensuing media consumption data with the first user identifier.

The above user tracking mechanisms are not limiting. Various methods for authenticating a user ID and/or associating consumption data with an appropriate user identifier may be used without departing from the scope of this disclosure.

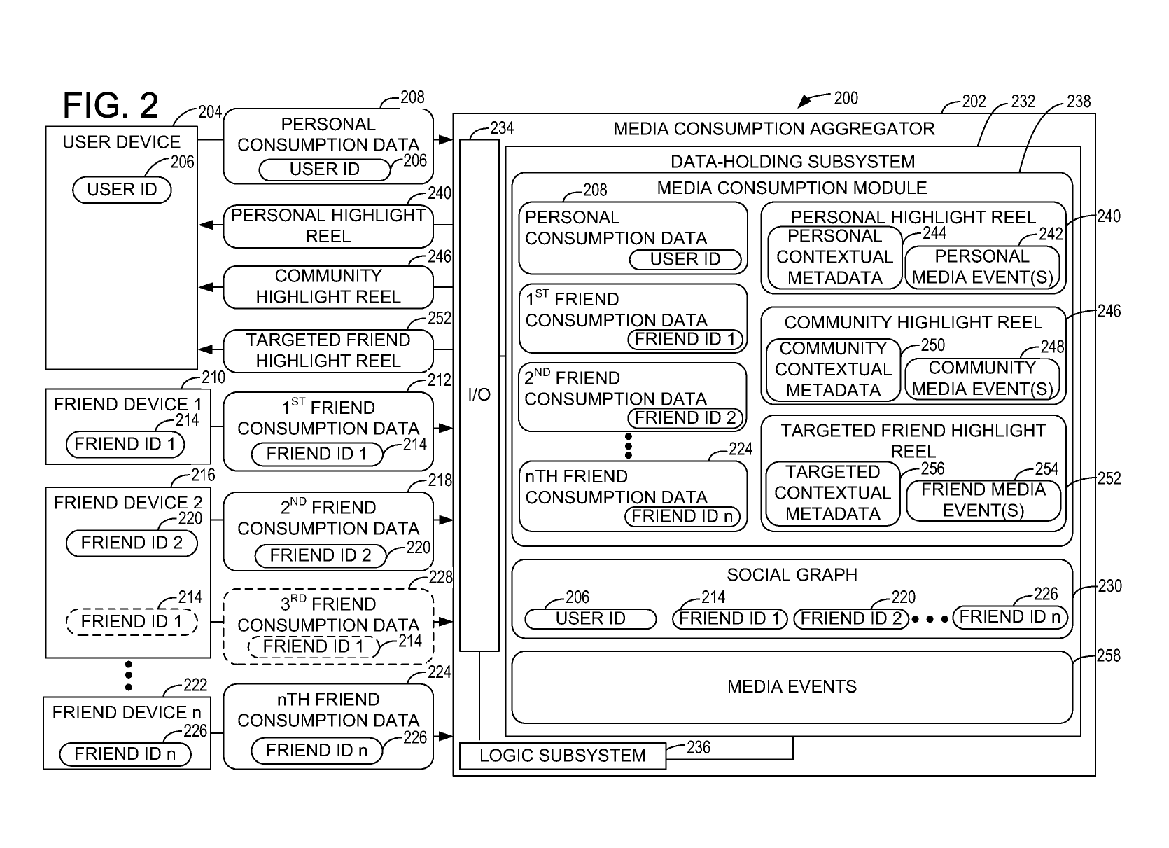

Turning now to FIG. 2, an example system 200 for generating highlight reels is schematically shown. Here, several devices (e.g., clients) are shown communicating with media consumption aggregator 202, an example of which may be media consumption aggregator 108 of FIG. 1. A user device 204 may be associated with a user identifier 206, and configured to send personal consumption data 208 associated with the user identifier 206 to the media consumption aggregator 202. Similarly, a first friend device 210 sends first friend consumption data 212 associated with first friend identifier 214 to the media consumption aggregator 202, a second friend device 216 sends second friend consumption data 218 associated with second friend identifier 220 to the media consumption aggregator 202, and nth friend device 222 sends nth friend consumption data 224 associated with nth friend identifier 226 to the media consumption aggregator 202.

As discussed with respect to FIG. 1, more than one user may consume media on any given device. An example of this is schematically shown in FIG. 2 where the media consumption aggregator 202 receives third friend consumption data 228 in association with the first friend identifier 214 from the second friend device 216. One example use scenario of this may include, for example, a female user (e.g., first friend identifier 214) using a mobile phone (e.g., first friend device 210) to consume media. The female user may also log into a family computer (e.g., second friend device 216) to consume media, where the female's brother (e.g., second friend identifier 220) can also log into the family computer (e.g., second friend device 216) to consume media. In both cases, media consumed by the female user is associated with a same first friend identifier 214, regardless of a device used to consume media. Thus, the system 200 is configured to receive media consumption data from a plurality of devices, and associate an appropriate identifier with the media consumption data.

Data may be received at the media consumption aggregator 202 via an input/output (I/O) interface 234, and instructions stored in data-holding subsystem 232 may be processed by a logic subsystem 236. As shown, the personal consumption data 208, first friend consumption data 212, second friend consumption data 218 and nth friend consumption data 224 are stored at a media consumption module 238 on data-holding subsystem 232. Although not shown, for simplicity, third friend consumption data 228 may be stored at the media consumption module 238.

At the media consumption aggregator 202, the user identifier 206 is associated with at least the first friend identifier 214, the second friend identifier 220, and the nth friend identifier 226 in a social graph 230. Each friend identifier may have a friend connection to the user identifier 206 in the social graph 230. In this example, social graph 230 is stored on data-holding subsystem 232 of the media consumption aggregator 202. In other scenarios, a social graph may be managed by a third party. In such cases, the social graph may be accessed, for example, via an Application Programming Interface.

The social graph 230 may be constructed based on explicit instructions from one or more of a user associated with the user identifier 206 and friends associated with respective friend identifiers. A friend identifier whose connection to the user identifier in the social graph is created in response to an explicit request from either or both of the user and the friend may be referred to as an explicit friend connection.

Additionally or alternatively, the social graph 230 may be constructed based on implicit actions by one or more of a user and friends. For example, if a user has common media tastes with a fourth friend but the user and/or fourth friend have not explicitly requested a friend connection, the media consumption aggregator 202 may, nevertheless, include a fourth friend identifier (not shown) in the social graph 230 with an implicit friend connection to the user identifier 206. Different rules, policies, and guidelines may govern acceptable actions (e.g., sharing, etc.) by friends represented by friend identifiers having explicit friend connections to the user identifier, and friends represented by friend identifiers having implicit friend connections to the user identifier in a social graph. As used herein, “friend identifier” may include a friend identifier with an explicit friend connection or an implicit friend connection to the user identifier in a social graph, such as social graph 230.

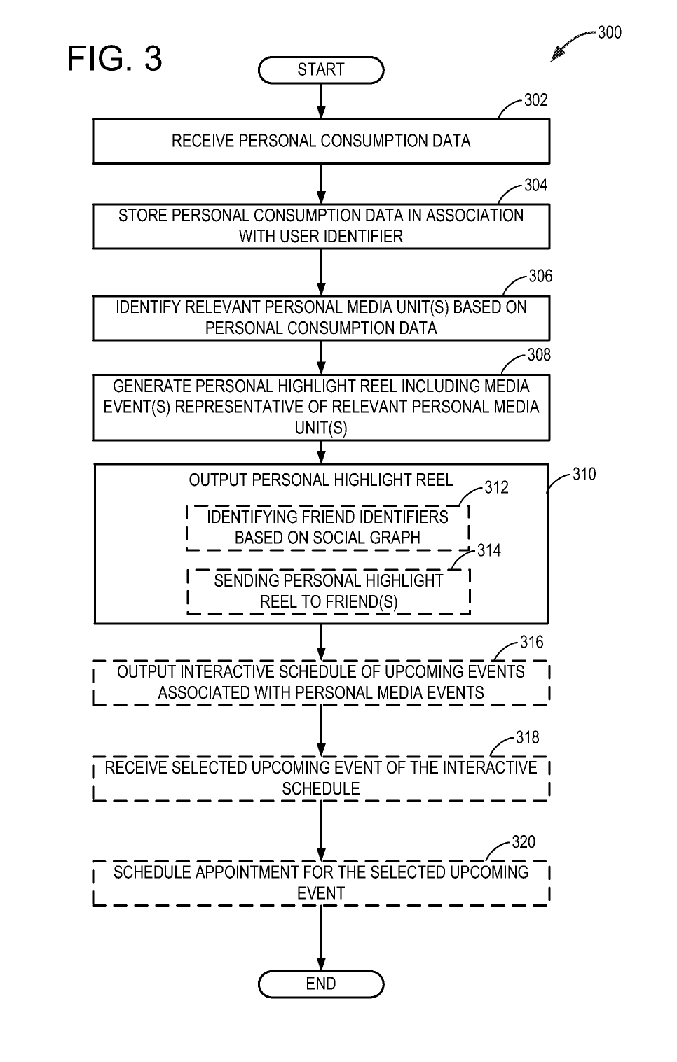

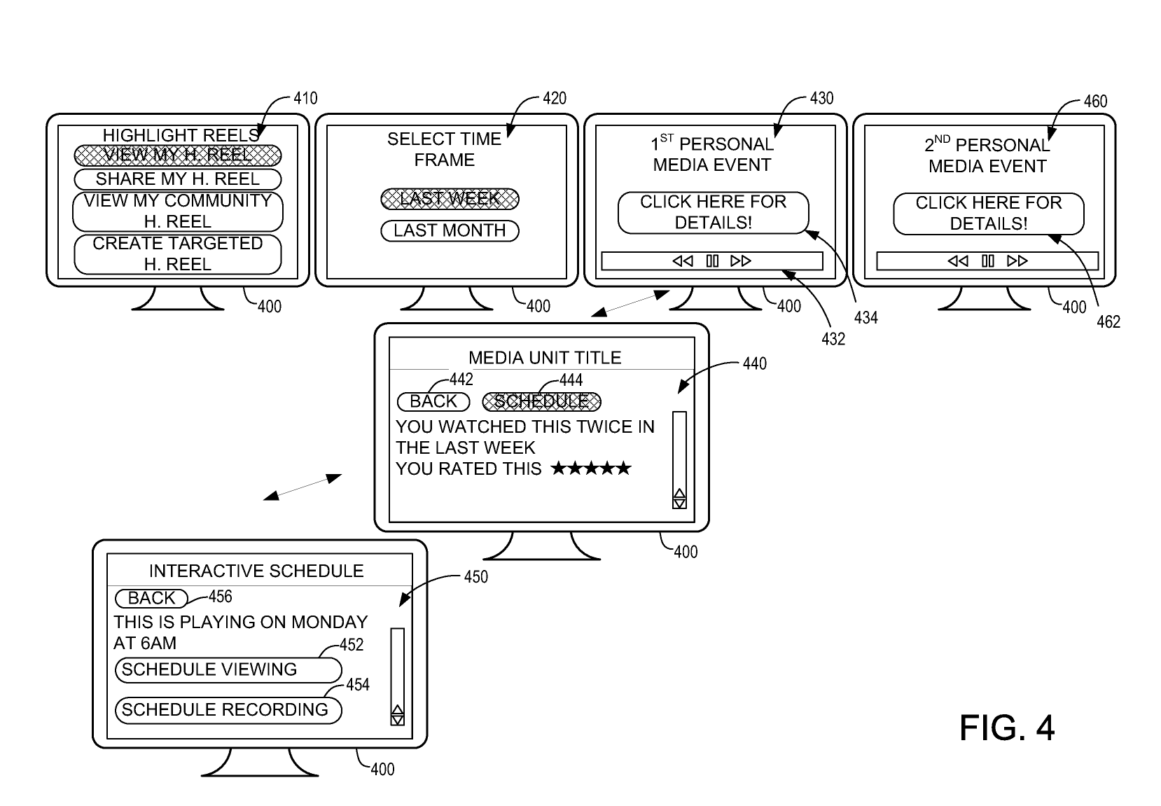

At the media consumption module 238, a personal highlight reel 240, including one or more personal media events 242 representative of relevant personal media units identified in the personal consumption data 208, may be generated, stored, and/or output to the user device 204. One example of a personal highlight reel, mentioned above, might include a series of video clips representative of television shows, movies, music, podcasts, and any other consumable media that the user has watched, listened to, or otherwise consumed lately. The determination of the one or more relevant personal media units, and the generation of the personal highlight reel are discussed in more detail with respect to FIG. 3 and FIG. 4.

In this example, the personal highlight reel 240 also comprises personal contextual metadata 244 including details associated with each of the personal media events 242. The personal contextual metadata 244 may include one or more of a number of viewings of a particular relevant personal media unit in association with the user identifier, time of viewing of the particular media unit in association with the user identifier 206, a rating of the particular media unit in association with the user identifier 206 (e.g., a rating by a user represented by the user identifier), and a recommendation of the particular media unit in association with the user identifier 206 (e.g., a recommendation by the user represented by the user identifier). In other examples, the personal contextual metadata 244 may be stored elsewhere. Further, a user may optionally select to keep private one or more aspects of the personal consumption data 208, and the personal contextual metadata 244 associated with the user identifier 206 may be protected and/or anonymized to maintain privacy accordingly.

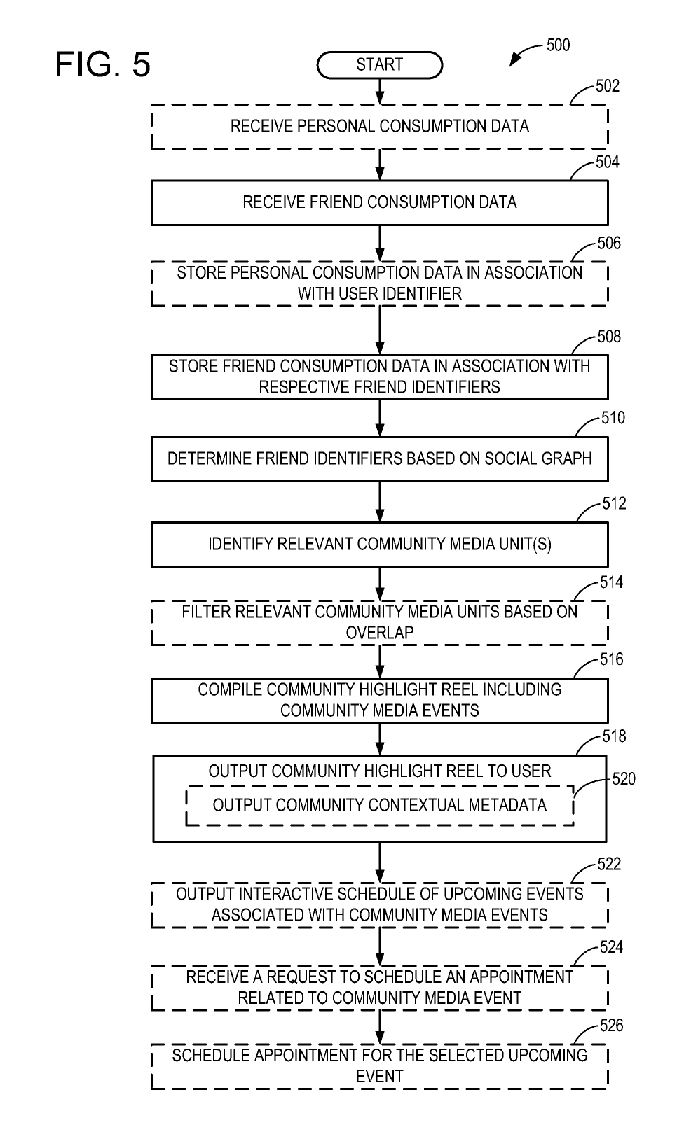

The media consumption module 238 is also configured to create and/or store a community highlight reel 246 which may be output to the user device 204. The community highlight reel 246 includes one or more community media events 248 representative of relevant community media units. Community media events 248 represent corresponding relevant community media units similar to how personal media events 242 represent corresponding relevant personal media units. Thus, an exemplary community highlight reel might include ten different video clips representing the top ten most-watched television shows or movies by the community members (e.g., all friends of a user). The relevant community media units may be determined from all (or less than all) of the first friend consumption data 212, second friend consumption data 218, third friend consumption data 228, nth friend consumption data 224, and/or any other friend consumption data associated with a friend identifier having a friend connection to the user identifier 206 in the social graph 230, in this example. Generation of the community highlight reel 246, including identification of relevant community media units, is discussed in more detail with respect to FIG. 5.

As shown in this example, the community highlight reel 246 further comprises community contextual metadata 250, which includes details associated with each of the community media events 248. The community contextual metadata 250 may include one or more of a number of viewers of a particular relevant community media unit represented by a particular community media event, a number of viewings of the particular relevant community media unit, a time of viewing of the particular relevant community media unit, a rating or average rating of the particular relevant community media unit, a number of ratings of the particular relevant community media unit (e.g., how many friends rated the particular relevant community media unit), a recommendation of the particular relevant community media unit in association with one or more of the friend identifiers (e.g., recommended by one or more friends), and a number of recommendations of the particular relevant community media unit in association with one or more of the friend identifiers (e.g., recommended by one or more friends).

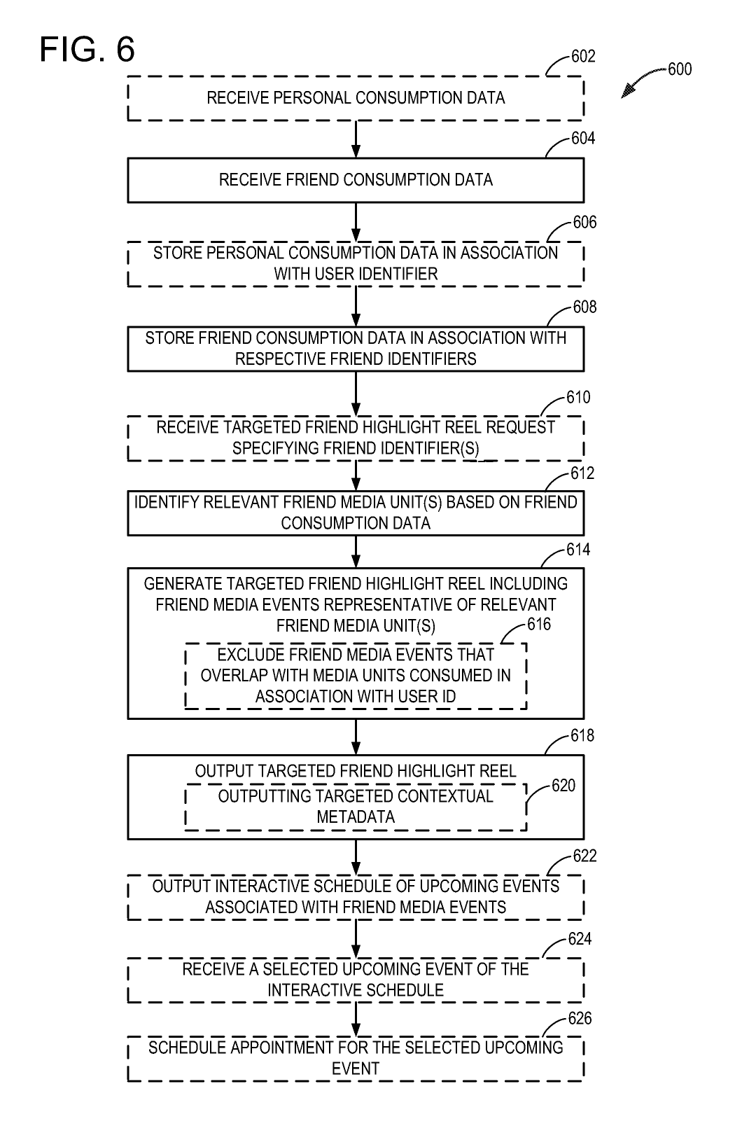

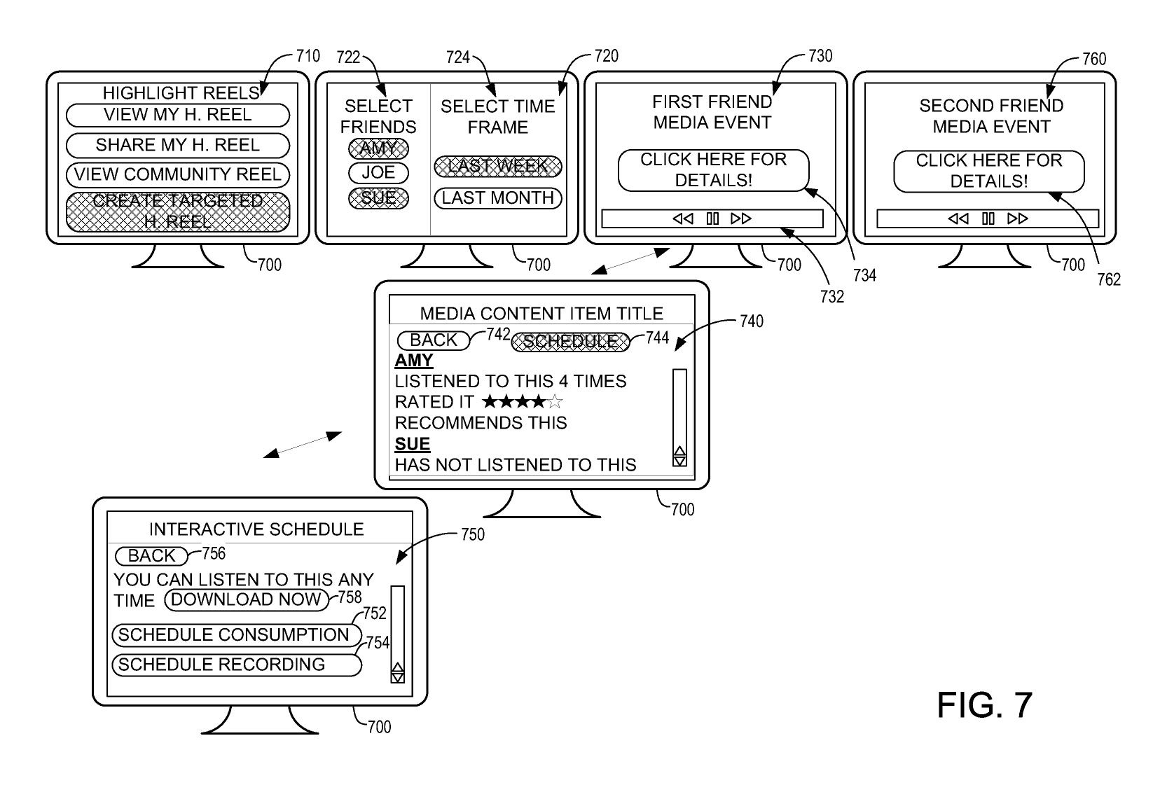

The media consumption module 238 also includes a targeted friend highlight reel 252 including one or more friend media events 254, representative of one or more relevant friend media units, which can be output to the user device 204. In some examples, the targeted friend highlight reel 252 is generated based on consumption data associated with user-selected friends that are represented by friend identifiers in the social graph 230. Friend media events 254 in the targeted friend highlight reel 252 may be similar to the personal media events 242 and community media events 248 in that the friend media events represent corresponding relevant friend media units. As such, an exemplary friend highlight reel may include one or more clips of television shows, movies, music, podcasts, etc. consumed by the user-selected friends that have been highly rated by the user-selected friends. Determination of the relevant friend media units and generation of the targeted friend highlight reel 252 are discussed in more detail with respect to FIG. 6 and FIG. 7.

The personal media events 242, community media events 248, and friend media events 254 may be selected from a pool of media events 258. Any of the personal media events 242, community media events 248, and friend media events 254 may overlap with one another or may be mutually exclusive. In another example, one or more of the media events 258 may be retrieved or received from a third party provider of media events that is separate from the media consumption aggregator 202.

It may be appreciated that a targeted friend highlight reel based on consumption data associated with a single friend identifier may be referred to as a personal highlight reel for that friend identifier.

As shown, the targeted friend highlight reel 252 also comprises targeted contextual metadata 256 including details associated with each of the relevant friend media units corresponding to the friend media events 254. The targeted contextual metadata 256 may include one or more of a number of the user-selected friends that have viewed a particular relevant friend media unit associated with a friend media event, a number of viewings of the particular relevant friend media unit, a time of viewing of the particular relevant friend media unit, a rating or average rating of the particular relevant friend media unit in association with one or more friend identifiers representing one or more user-selected friends, a number of ratings of the particular relevant friend media unit, a recommendation by one or more of the user-selected friends, and a number of recommendations by the one or more user-selected friends.

It may be appreciated that a targeted friend highlight reel based on consumption data associated with a single friend identifier may be referred to as a personal highlight reel for the friend represented by the single friend identifier. However, in other cases, the targeted friend highlight reel based on consumption data associated with the single friend identifier is dissimilar to the personal highlight reel for the friend represented by the single friend identifier.

It may be appreciated that, although the user device 204 is named as such, the user device 204 may be considered a friend device and friend devices may be considered user devices, in other use scenarios. Similarly, it may be appreciated that any of the personal highlight reel 240, the community highlight reel 246, and the targeted friend highlight reel 252 can be output to any of the user device 204, first friend device 210 second friend device 216, and nth friend device 222, and/or any other device.

In general, the identification of relevant personal media units, relevant community media units, and relevant friend media units may be based on weighted factors, so that some factors affect the likelihood of a media event being included in a highlight reel more than other factors. In some examples, a user may be able to assign the weights to the factors.

Furthermore, any of the relevant personal media units, relevant community media units, and relevant friend media units may be identified based on one or more user-defined factors. That is, a user may optionally identify factors according to which relevant personal media units, relevant community media units, and/or relevant friend media units can be identified (e.g., most-watched, most-recommended, genre preferences, music preferences, etc.).

Furthermore, the identification of the relevant personal media units, relevant community media units, and relevant friend media units may be dependent on sharing rules and privacy settings set by each of the user and the user's friends. That is, if a particular media unit consumed is associated with a “private” status marker, the particular media unit consumed may not be identified as any of a relevant personal media unit, a relevant community media unit, or a relevant friend media unit.

Further still, if a user device or friend device is a smart device (e.g., having a camera) and/or is otherwise capable of user recognition, then identification of relevant personal media units, relevant community media units, and relevant friend media units may be additionally based on implicit information observable by the smart device. Such implicit information may include an elicitation of laughter observed by a smart device, elicitation of a recognizable facial emotion by the smart device, or any other observable pattern by the smart device. Such a smart device may be further configured to recognize users and appropriately associate a user with the user's user identifier, so that the user identifier can be appropriately included in media consumption data.

In general, the generation of a personal highlight reel, a community highlight reel, and/or a targeted friend highlight reel may occur when a time threshold has been reached. For example, a personal highlight reel may be generated and/or updated every two days. As another example, the generation of a personal highlight reel, a community highlight reel, and/or a targeted friend highlight reel may occur when a volume threshold of consumed media units has been reached. For example, a targeted friend highlight reel may be generated for the user once each of a plurality of user-selected friends has each consumed a particular number of media units (e.g., 5 media units). As a more specific example, a targeted friend highlight reel may be generated once each of the user-selected friends have each consumed at least 5 media units since a user's last request for a targeted friend highlight reel having those same user-selected friends.

Additionally, consumption data may be received at a media consumption aggregator from other users of the media consumption aggregator (not shown) whose corresponding identifiers may not have an explicit or implicit friend connection to the user identifier in the user's social graph. Based on a particular user's settings, consumption data from these other users may be included in a community highlight reel, even though they are not friends of the user.

In yet another example, a public highlight reel may be created that is accessible to one or more users of a media consumption aggregator, where the public highlight reel is based on media consumption data of one or more (e.g., all) users of the media consumption aggregator, regardless of friend connections in any social graph. Such a public highlight reel can be generated based on media consumed by all users. A public highlight reel might include video clips and audio clips of most popular media overall, and/or associated public contextual metadata.

Turning now to FIG. 3, a flowchart illustrates an exemplary method 300 for generating a personal highlight reel. At 302, the method 300 includes receiving personal consumption data which may be associated with a user identifier. The personal consumption data indicates one or more media units (e.g., movie, TV show, video game, podcast, song) that have been consumed by a user computing device. At 304, the method 300 includes storing the personal consumption data in association with the user identifier. As discussed above, consumption data may be associated with a user identifier once it is received.

At 306, the method 300 includes identifying one or more relevant personal media units based on the personal consumption data. This may include, for example, identifying one or more media units that have been consumed by a user represented by the user identifier a threshold number of times. Thus, in one example, a relevant personal media unit may be a TV show that was viewed, in association with the user identifier, a highest number of times compared to all TV shows viewed in association with the user identifier.

The identifying of one or more relevant personal media units at 306 may include identifying media units consumed for a threshold duration, from the personal consumption data. For example, if an entirety of a movie was watched, the movie may be considered a relevant personal media unit whereas if only two-thirds of another movie was watched, the other movie may not be considered a relevant personal media unit.

Further still, the identifying of one or more relevant personal media units may include identifying media units that have been rated in association with the user identifier. That is, a user may rate a media unit on a numerical scale, as a number of stars, or with a binary scale (e.g., “like it” v. “don't like it”), as just some examples. As such, media units that are rated a predetermined threshold or higher (e.g., 4 or more stars, out of 5 stars) may be included as relevant personal media units. Alternately, identifying one or more relevant personal media units may include identifying which (if any) media units consumed in association with the user identifier were also recommended in association with the user identifier. As an example, if a user recommends a podcast in general, or to a specific friend (e.g., via e-mail, via a social networking application) the podcast may be considered a relevant personal media unit, because the podcast was recommended in association with the user identifier that represents the user.

Further, identifying relevant personal media units may include identifying a media unit that has been consumed a most number of minutes in a time period, identifying a media unit for which a highest number of episodes has been consumed within a time period, and/or identifying a media unit for which a highest number of new episodes (e.g., a first broadcasting of an episode) has been consumed within a time period.

A relevant personal media unit may be a portion of a video. For example, a relevant personal media unit may include video of a popular sports play (e.g., 15 seconds concluding with a goal), which may be a portion of a larger video containing an entire sports game. As another example, a relevant personal media unit may be a particular sequence of events in a video game played by a user (e.g., a duel scene). Further still, a relevant personal media unit may be a portion of an audio file, such as a chorus of a song. Alternately, a relevant personal media unit may be a series of videos, such as scenes from several episodes of a TV series, or a series of audio files, such as a set of music albums.

Virtually any criteria may be used to assess which media units are considered relevant for purposes of creating a highlight reel. The above examples provided with respect to identifying relevant media units are not limiting.

At 308, the method 300 includes generating a personal highlight reel including one or more personal media events representative of the one or more relevant personal media units. The personal media events may include one or more of a media trailer (e.g., movie trailer, TV episode teaser), a media synopsis (e.g., in text or video format), a popular media segment (e.g., a chorus of a song, a popular movie scene), and an editorially-identified media segment (e.g., top 30 seconds of a TV show).

In some examples, the generating at 308 may also include linking personal contextual metadata to each of the personal media events in the personal highlight reel (e.g., a number of viewings, a time of day of viewing, etc.). Personal contextual metadata may include one or more of a consumption statistic, a rating, and a recommendation of a relevant personal media unit that is represented by a respective personal media event. In some embodiments, a visual representation of such linked contextual metadata may be integrated into the highlight reel (e.g., a text representation of a rating may be overlaid on a video background), as described below.

At 310, the method 300 includes outputting the personal highlight reel. For example, the personal highlight reel may be sent to a user computing device associated with the user identifier. As another example, the personal highlight reel may be posted to a personal website associated with the user identifier, or to a social networking application. In still other examples, user input is not involved in the outputting of the personal highlight reel, and the personal highlight reel is simply output and presented to the user, output to a personal website associated with the user, and/or posted to a social networking application.

In some cases, the outputting at 310 optionally includes identifying friend identifiers having a friend connection to the user identifier in a social graph, at 312, and sending the personal highlight reel to at least one friend computing device associated with at least one of the friend identifiers, at 314. In another example, the personal highlight reel may be broadcast to the friend identifiers, or to a subset of the friend identifiers. Further still, the personal highlight reel may be sent to friend computing devices at a predetermined schedule (e.g., once a week), or may be sent to a friend computing device responsive to receiving a request from a friend identifier for the personal highlight reel.

In general, it is to be understood that a highlight reel can be pushed to a computing device without an explicit request from the computing device receiving the highlight reel. Further, it is to be understood that a highlight reel can be pulled to a computing device only after that computing device requests the highlight reel.

As will be appreciated upon review of FIG. 4, the method 300 may optionally include outputting an interactive schedule of upcoming events associated with at least one of the personal media events at 316, receiving a selected upcoming event of the interactive schedule at 318, and scheduling an appointment for the selected upcoming event at 320.

Turning now to FIG. 4, various example user interfaces by which a client may access a personal highlight reel are shown. The user interfaces depicted in FIG. 4 are in no way limiting. Instead, the example user interfaces are provided as example implementations in accordance with the present disclosure. While the examples of FIG. 4 focus on the viewing of a personal highlight reel by a user reviewing past media experiences, this is in no way limiting. As explained below with reference to other examples, a highlight reel from another person or group of people may be viewed by a user, and such highlight reels may help a user find media that the user has not already experienced.

In the illustrated example, a display 400 may be operatively coupled to a client that is communicating with a media consumption aggregator, such as media consumption aggregator 202 of FIG. 2. A first user interface 410 shows a menu that facilitates user control of the highlight reel experience. In this nonlimiting example, the first user interface 410 includes selectable highlight reel buttons titled “View My Highlight Reel”, “Share My Highlight Reel”, “View My Community Highlight Reel”, and “Create a Targeted Friend Highlight Reel”. An input indicating selection of the first highlight reel button “View my Highlight Reel” may be received, and the display updated to reflect said selection (e.g., by cross-hatching of the first highlight reel button), in this example.

In response to receiving an input indicating selection of the first highlight reel button, a second user interface 420 is presented on the display 400, in this example. The second user interface 420 includes selectable time frame buttons indicating time frames for which a personal highlight reel is to be created, in this example. The second user interface 420 includes selectable time frame buttons “Last Week” and “Last Month”, though various pre-set and user-configurable options are possible, in this and any other examples.

In this example, upon receiving an input indicating selection of time frame button “Last Week”, the second user interface 420 is updated to reflect said selection (e.g., by cross-hatching), and a request for the personal highlight reel may be sent to the media consumption aggregator. Thereafter, the personal highlight reel may be generated at the media consumption aggregator according to the selected inputs. In this example, the personal highlight reel will be generated based on media units consumed in association with the user identifier in a preceding week.

In other examples, other selectable input options upon which to base the generation of a personal highlight reel may be presented on a user interface. Some other selectable input options may include a length or duration of the personal highlight reel, types of media to include and/or types of media to exclude, as just some examples. In still other examples, selectable input options may be absent.

After generation and/or retrieval of the personal highlight reel, a third user interface 430 displays a first personal media event of the personal highlight reel. The first personal media event is representative of a first relevant personal media unit, and may include a popular movie clip, in this nonlimiting example. For simplicity of illustration, the media event is visually simplified as a textual description. However, it is to be understood that a highlight reel may be presented in any suitable manner, such as a full screen, full motion video.

Additionally on the third user interface 430, a toolbar 432 provides actuatable controls by which a user can request a pause, rewind, or fast-forward of the personal highlight reel, as just some examples. Further, a first details icon 434 is actuatable to display personal contextual metadata associated with the first personal media event. In this nonlimiting example, upon selection of the first details icon 434, displaying of the first personal media event may be paused and a fourth user interface 440 may be displayed. On the fourth user interface 440, a media unit title of the first relevant personal media unit associated with the first personal media event is displayed, and personal contextual metadata is also displayed as formatted text. The personal contextual metadata may include consumption history of the first relevant personal media unit by the user and a rating of the first relevant personal media unit made by the user, as shown. In other examples, the personal contextual metadata may be presented to a user as a voice-over and/or as a textual overlay.

Additionally, a selectable back button 442 may allow a user to navigate back to presentation of the personal highlight reel. A selectable schedule button 444 is also displayed on the fourth user interface 440. Upon receiving an input indicating selection of the schedule button 444, an interactive schedule of upcoming events, related to the first relevant personal media unit represented by the first personal media event, may be output by the media consumption aggregator to a user interface.

In this nonlimiting example, selection of the schedule button 444 of fourth user interface 440 results in a display of fifth user interface 450. As an example, if the first friend media event is representative of an episode of a sitcom TV show, the fifth user interface 450 may display future showings of a different or a same episode of the sitcom TV show. Additionally, the fifth friend user interface 450 may display future showings of other sitcom TV shows and/or movies that include cast members from the sitcom TV show, as just some further examples.

As another example, if the first friend media event is a sports game between a first team and a second team, the fifth friend user interface 450 may display future showings of sports games including either or both of the first team and the second team. Further still, the fifth friend user interface 450 may display future showings of all other sports games or sports-related media.

On the fifth user interface 450, the user is presented with a schedule viewing button 452, selection of which will indicate a user's request to schedule an appointment related to an upcoming event from the interactive schedule. As a result, the media consumption aggregator may receive the request for scheduling a viewing of the selected upcoming event. Upon receipt of the input indicating the request to schedule the viewing, a calendar entry for a viewing appointment related to the selected upcoming event may be entered for the user on a client running on a user computing device, or on the media consumption aggregator. That is, the media consumption aggregator may be configured to schedule an appointment related to the selected upcoming event, or to request scheduling of an appointment.

Scheduling of a viewing appointment may include inviting one or more friends to view a media unit, remotely, at a same time as the user's viewing appointment. Alternately, scheduling a viewing appointment may include inviting one or more friends to physically join the user for the viewing. Said inviting may include sending an e-mail, or other type of notification to one or more friend devices associated with the one or more friend identifiers. Alternately, said inviting may include sending a notification to a website, or social networking application, where the notification is viewable, or retrievable, by one or more friends associated with the one or more friend identifiers.

Referring again to the example illustrated by FIG. 4, receipt of an input indicating selection of a schedule recording button 454 of fifth user interface 450 may be received. Upon receiving the input indicating selection of the schedule recording button 454, a recording appointment may be entered for the user, on the client or on the media consumption aggregator. In one example, the recording appointment may indicate that a recording of the selected upcoming event is to automatically occur at a specified time.

In this nonlimiting example, a user can navigate back to the personal highlight reel via actuation of a schedule back button 456, from the fifth user interface 450. The first personal media event may then continue playing, on the third user interface 430, from a location within the personal highlight reel at which it was paused, before display of the fourth user interface 440 was initiated, in this example. Upon completion of displaying of the first personal media event at third user interface 430, the second personal media event may automatically begin displaying on a sixth user interface 460. Again, for simplicity, the second personal media event is shown as text, though any form is possible.

As an alternate example, once the user navigates backward from the fifth user interface 450 to return to presentation of the personal highlight reel, the sixth user interface 460 may be automatically displayed with a second details icon 462 on the sixth user interface 460. The second personal media event displayed on the sixth user interface 460 is associated with a second relevant personal media unit. Upon receiving an input indicating selection of the second details icon 462, a user is presented with one or more user interfaces similar to fourth user interface 440 but differing from fourth user interface 440 by relation to the second personal media event as opposed to the first personal media event. Similarly, a user may be presented with an option to proceed to a user interface with an interactive schedule, similar to fifth user interface 450, but differing from fifth user interface 450 by relation to the second personal media event, as opposed to the first personal media event.

Furthermore, it is to be understood that generation of a personal highlight reel may occur in response to a user's request for the personal highlight reel, as described in the example of FIG. 4, where user selection of a selectable highlight reel button is received. However, in a different example, the personal highlight reel may be automatically generated and stored (e.g., at a media consumption aggregator) at a predetermined schedule (e.g., once a day). In such a case, upon receiving a user request to view the personal highlight reel, the personal highlight reel may simply be retrieved (e.g., from the media consumption aggregator). Further still, the personal highlight reel may be presented in absence of a user request.

It is notable that the user interfaces of FIG. 4 are examples and are not meant to be limiting in any way. Highlight reels may be created, controlled, delivered, presented, and/or viewed in any suitable way without departing from the scope of this disclosure. Various configurations and layouts of user interfaces for displaying menus, selectable options, media events, contextual metadata, and/or schedules are conceivable, and may include any of text, graphics, and/or sound.

Furthermore, in some examples, a highlight reel may be available only as audio information and a display may or may not be coupled to an audio presentation device (e.g., mp3 player, etc.) In a case where a display is not coupled to an audio presentation device, a user may be able to actuate one or more controls of the audio presentation device to interact with, or view one or more of a personal highlight reel, a community highlight reel, and/or a targeted friend highlight reel.

Various other implementations of highlight reels may be possible. For example, highlight reels may be integrated into other user experiences, such that creation, control, delivery, presentation, and/or viewing of highlight reels are integrated with, for example, a social networking application, an e-mail application, a music experience application, or any other application executed in connection with a user computing device. In some embodiments, creation of highlight reels may be transparent to a user.

In one example, where a highlight reel is integrated into a social networking experience, a selectable graphic may be integrated into a user interface, whereupon selection of the selectable graphic causes presentation of one or more highlight reels (e.g., a personal highlight reel, a community highlight reel, a targeted friend highlight reel). In another example, personal highlight reels may be automatically displayed to a user, in the absence of a user request.

In addition to, or instead of generating a personal highlight reel, a user represented by a user identifier may wish to discover media consumed by one or more members of the user's social community (e.g., one or more friends) by viewing a highlight reel that is based on consumption data associated with one or more friend identifiers having a friend connection to the user identifier in a social graph. A method 500 for generating such a community highlight reel is described with respect to FIG. 5, and a method 600 for generating a targeted friend highlight reel is described with respect to FIG. 6. A community highlight reel may differ from a targeted friend highlight reel by, at least, a number of friends whose associated media consumption data is considered during generation thereof. For example, a community highlight reel may be based on the consumption data of all of the members of a user's social community (e.g., all of the user's friends). In contrast, a targeted friend highlight reel may be based on the consumption data of only a subset of all of the user's friends, where the subset may or may not be selected by the user.

Referring now to FIG. 5, a method 500 for generating a community highlight reel is described. At 502, the method 500 optionally includes receiving personal consumption data indicating media units consumed by a user computing device. At 504, the method 500 includes receiving friend consumption data indicating media units consumed by friend computing devices. At 506, the method 500 optionally includes storing the personal consumption data in association with a user identifier. At 508, the method 500 includes storing the friend consumption data in association with respective friend identifiers.

At 510, the method 500 includes determining friend identifiers associated with the user identifier based on a social graph of connections between the user identifier and the friend identifiers. At 512, the method 500 includes identifying relevant community media units, from the friend consumption data associated with the friend identifiers determined at 510. The identification of relevant community media units may be based at least on a consumption frequency. This may include identifying relevant community media units based on one or more of a threshold number of times a particular media unit has been consumed (e.g., a number of consumptions) in a time period by the friends associated with the friend identifiers, and a threshold number of friends that have consumed the particular media unit. Additionally or alternatively, the identifying of relevant community media units may be based on a rating or a recommendation of a particular media unit that is associated with one or more of the friend identifiers (e.g., media units that have been rated and/or recommended by one or more friends).

In still other examples, identifying relevant community media units may include determining particular episodes of a TV show with a highest play count among the friends, and/or identifying a media unit with most aggregate minutes consumed, among the friends. Further still, identifying a relevant community media unit may include identifying a media unit with a highest sum of new episodes consumed, among the friends, where the media unit is, for example, a television series.

Further, the identifying of relevant community media units may include determining a strength of connection between the user identifier and each of the friend identifiers and weighting media consumption data associated with the friend identifiers based on the strength of connection to the user identifier. For example, if a particular friend identifier has a weak connection with the user identifier (e.g., a friend that infrequently interacts with and/or influences the user), the consumption data associated with the particular friend identifier may be weighted with a lesser weight when generating the community highlight reel.

The identification of relevant community media units may include any methods described with respect to the identification of relevant personal media units described above, where the methods are appropriately modified to identify relevant community media units consumed by members of the community as opposed to identifying relevant personal media units consumed by the user represented by the user identifier.

At 514, the method 500 optionally includes filtering the relevant community media units based on overlap between the relevant community media units and the media units consumed by the user computing device to thereby generate filtered relevant community media units. That is, the filtering may include comparing the relevant community media units with all (or some) media units consumed by the user represented by the user identifier, identifying any relevant community media units that have been consumed by the user represented by the user identifier, and removing those relevant community media units that have been consumed by the user represented by the user identifier from a pool of relevant community media events. In this way, media events related to media units the user has already consumed are not included in a community highlight reel. However, in some cases, this feature may not be included. A user may specify a preference to include overlapping media units based on an overlapping factor (e.g., a rating of the media unit by the user, a user-specified rule regarding overlapping media units, etc.).

At 516, the method 500 includes compiling, or generating, a community highlight reel including community media events representative of the filtered relevant community media units. Similar to personal media events, the community media events may include one or more of a media trailer, a media synopsis, a popular media segment, and an editorially-identified media segment.

The compiling may include linking community contextual metadata to each of the community media events, where the community contextual metadata specifies one or more of the friends associated with each of the community media events and an amount of consumption of each media unit by the one or more of friends. For example, a particular video clip may be linked to contextual metadata specifying that friends A, B, and C consumed a movie associated with the video clip, that friend A consumed the movie twice, and that friends B and C each consumed the movie once. Further, the community contextual metadata may include one or more of a consumption statistic, a rating, and a recommendation associated with each of the relevant community media units represented by respective community media events.

At 518, the method 500 includes outputting the community highlight reel for presentation. If community contextual metadata has been linked to community media events, the outputting of the community highlight reel includes outputting the community contextual metadata at 520.

The method 500 optionally includes outputting an interactive schedule of upcoming events associated with the community media events at 522. The method 500 may also include receiving a request to schedule an appointment related to one of the community media events of the community highlight reel at 524. In one example, this may include receiving an input indicating a selected upcoming event of the interactive schedule. In response to receiving the request to schedule the appointment, the method 500 optionally includes scheduling an appointment for the selected upcoming event at 526. The scheduling of the appointment may include, for example, scheduling a viewing appointment or a recording appointment. One or more friends may be invited to a viewing appointment or a recording appointment. A detailed description of steps 522-526 is omitted here and the reader is referred to the description of similar steps with respect to FIG. 3 and FIG. 4 above.

Turning now to FIG. 6, a method 600 for generating a targeted friend highlight reel is described. At 602, the method 600 optionally includes receiving personal consumption data indicating media units consumed by a user represented by a user identifier. At 604, the method 600 includes receiving friend consumption data indicating friend media units consumed in association with friends represented by respective friend identifiers. At 606, the method 600 optionally includes storing the personal consumption data in association with the user identifier. At 608, the friend consumption data is stored in association with the respective friend identifiers.

At 610, the method 600 optionally includes receiving a targeted friend highlight reel request specifying at least one of a plurality of friend identifiers upon which to base the generation of the targeted friend highlight reel. That is, generation of a targeted friend highlight reel may be based on the media consumption data associated with a single friend identifier. In other examples, a user can specify several friends, a predefined group of friends or a characteristic by which friends are to be specified for this instance of a targeted friend highlight reel.

The method 600 may include identifying one or more relevant friend media units based on friend consumption data associated with the at least one of the plurality of friend identifiers, at 612. The identification of relevant friend media units may include any methods for identifying relevant personal media units and/or method for identifying relevant community media events described above, where the methods above would be appropriately modified to identify relevant friend media units consumed by the at least one friend identifier (e.g., one or more user-selected friends to be included in the targeted friend highlight reel), as opposed to identifying media units consumed by the user identifier or by friend identifiers included in the generation of the community highlight reel.

At 614, the method 600 includes generating the targeted friend highlight reel including friend media events representative of the one or more relevant friend media units. In some cases, the generating at 614 optionally includes excluding friend media events representative of relevant friend media units that overlap with media units that have been consumed in association with the user identifier, at 616. For example, if a friend media event is a video clip of a television show that the user has watched recently, that video clip may be excluded from the targeted friend highlight reel. This excluding may be similar to the filtering described at 514 of method 500.

Returning to FIG. 6, the method 600 includes outputting the targeted friend highlight reel at 618, which optionally includes outputting targeted contextual metadata at 620. Targeted contextual metadata may specify one or more friend identifiers associated with each of the friend media events. The targeted contextual metadata may also include one or more of a consumption statistic, a rating, and a recommendation associated with each of the relevant friend media units represented by respective friend media events.

As mentioned above, the generation of a highlight reel, such as a targeted friend highlight reel, may be transparent to a user. Accordingly, the targeted friend highlight reel may be output to a user in the absence of user input, or a user request for the targeted friend highlight reel. In one nonlimiting example, a user may navigate to a friend's personal website, or a friend's page on a social networking application. At the personal website, or page, a targeted friend highlight reel based on the media consumption data of only that friend may be automatically presented to the user.

At 622, the method 600 optionally includes outputting an interactive schedule of upcoming events associated with one or more of the friend media events of the targeted friend highlight reel. At 624, the method 600 optionally includes receiving a selected upcoming event of the interactive schedule and, in response, scheduling an appointment for the selected upcoming event at 626. A description of steps 622-626 is omitted here, and the reader is referred to a description of similar steps described above with respect to FIG. 3 and FIG. 4

Turning now to FIG. 7, an example schematic view of various user interfaces by which a user may access a targeted friend highlight reel is shown. The user interfaces depicted in FIG. 7 are in no way limiting. Instead, the example user interfaces are provided as example implementations in accordance with the present disclosure. While the examples of FIG. 7 focus on the presentation of a targeted friend highlight reel by a user reviewing past media experiences of a plurality of friends, this is in no way limiting. As explained herein, a highlight reel from another person or group of people may be viewed by a user, and such highlight reels may help a user find media that the user has or has not already experienced.

Although an exemplary sequence of user interfaces is described, this sequence is not meant to be limiting in any way. Any other sequence of user interfaces that does not depart from the scope of this application, is possible.

A display 700 may be coupled to a client that is communicating with a media consumption aggregator, such as media consumption aggregator 202 of FIG. 2. The display 700 may be configured to display a number of friend user interfaces, where a first friend user interface, second friend user interface, etc. refer to a sequence of user interfaces, in this example. The first friend user interface 710 shows a menu of highlight reels. The first friend user interface 710 includes selectable highlight reel buttons respectively titled “View My Highlight Reel”, “Share My Highlight Reel”, “View My Community Highlight Reel”, and “Create a Targeted Friend Highlight Reel”. In this nonlimiting example, an input indicating selection of the fourth friend highlight reel button “Create a Targeted Friend Highlight Reel” is received, and the display is updated to reflect the selection of the fourth friend highlight reel button (e.g., by the cross-hatching).

In response to receiving an input indicating selection of the fourth friend highlight reel button, a second friend user interface 720 is presented on the display 700. The second friend user interface 720 includes a menu of selectable friend buttons 722, and a menu of selectable time frame buttons 724 indicating, respectively, which friends and which time frames the generation of the targeted friend highlight reel can be created for.

In this example, the selectable friend buttons are configured such that each friend identifier having a friend connection to a user identifier in a social graph is associated with one of the selectable friend buttons. In this example, a user input indicating a selection of selectable friend button “Amy” and a user input indicating a selection of selectable friend button “Sue” have been received, indicated by the cross-hatching. In another example, each of the selectable friend buttons may be associated with a plurality of friend identifiers representing a plurality of friends having a common characteristic (e.g., location, age). In such a case, receiving a user input indicating a selection of one of the selectable friend buttons indicates a selection of the plurality of friend identifiers representing the plurality of friends having the common characteristic. In yet another example, each of the selectable friend buttons may be associated with a plurality of friend identifiers that have been identified, or organized, by the user (or another user) as a group (e.g., family, co-workers).

The second friend user interface 720 shown in FIG. 7 also illustrates selectable friend time frame buttons “Last Week” and “Last Month”, though various pre-set and user-configurable friend time frame buttons are possible. In this example, a user input indicating a selection of the selectable friend time frame button “Last Week” has been received and said selection is indicated by cross-hatching.

In response to receiving the selections of one or more selected friend identifiers and a selected friend time frame, a request for the targeted friend highlight reel may be received at the media consumption aggregator. In this example, the targeted friend highlight reel may thereafter be created at the media consumption aggregator based on consumption data associated with Amy's friend identifier and Sue's friend identifier in the last, or preceding, week.

Further selectable input options upon which to base the generation of a targeted friend highlight reel may be presented on any of the friend user interfaces. Some other selectable input options may include a length of the targeted friend highlight reel, types of media to include types of media to exclude, etc. However, as the example of FIG. 7 is not meant to be limiting, it can be appreciated that the creation of the targeted friend highlight reel may not be based on user input in other examples. That is, generation of targeted friend highlight reels can be automatic.

A third friend user interface 730 displays a first friend media event of the targeted friend highlight reel. As an example, the first friend media event may be album artwork related to a song that was listened to by Amy and/or Sue in the last week.

A toolbar 732 on the third user interface provides actuatable controls by which a user can request a pause, rewind, or fast-forward of the targeted friend highlight reel, or of a media event within the targeted friend highlight reel, as just some examples.

Additionally on the third friend user interface 730, a friend details icon 734 is linked to displaying of targeted contextual metadata associated with the first friend media event. Accordingly, upon selection of the friend details icon 734, a fourth friend user interface 740 may be displayed, while displaying of the first friend media event on the third friend user interface 730 may be paused. On the fourth friend user interface 740, a media unit title of a first relevant friend media unit associated with the first friend media event is displayed along with targeted contextual metadata in the form of formatted text. The text representation of targeted contextual metadata includes Amy's and Sue's respective media consumption history, ratings, and recommendations associated with the first relevant friend media unit that is represented by the first friend media event.

In this example, the targeted contextual metadata is displayed individually for each friend (e.g., Amy and Sue). However, the targeted contextual metadata can be displayed in any form, such as an aggregation of information, or as statistics (e.g., a number of friends that have consumed the media unit, an average rating, etc.). In yet another example, targeted contextual metadata may be presented as voice-over information such that it is audibly presented to a user.

Additionally on the fourth friend user interface 740, a friend back button 742 allows a user to navigate back to presentation of the targeted friend highlight reel. Also, selection of a friend schedule button 744 on the fourth friend user interface allows the user to navigate to a fifth friend user interface 750. The fifth friend user interface 750 displays a schedule of media units related to the first relevant friend media unit (e.g., a future showing of the first relevant friend media unit, a future showing of a media unit similar to the first relevant friend media unit). In this example, a media unit related to the first relevant friend media unit is available at any time (e.g., the first relevant friend media unit is a downloadable media, on-demand TV, etc.)

In this example, a user can select a download now button 758, and the media unit can be downloaded or streamed for current or future consumption. Alternately, a user can select schedule viewing button 752, and the media consumption aggregator may then receive a request to schedule a consumption appointment for a media unit related to the first relevant friend media unit. Upon receipt of an input indicating selection of the schedule consumption button 752, a calendar entry may be entered for the user on a client operating on a user computing device, or on the media consumption aggregator. That is, the media consumption aggregator may schedule an appointment for the selected upcoming event.

As discussed with respect to FIG. 4, scheduling of a viewing appointment may additionally include inviting one or more friends to consume a media unit, remotely, at a same time as the user's viewing appointment. Alternately, scheduling an appointment may include inviting one or more friend identifiers to physically join the user identifier for the consumption. Again, the reader is referred to the related description of viewing appointments and recording appointments made with respect to FIG. 3 and FIG. 4, above.

A schedule recording button 754 of the fifth friend user interface 750 can be selected by the user to indicate a request to schedule a recording of a media unit of the interactive schedule. Upon receiving an input indicating selection of the “Schedule Recording” button, a calendar entry and/or other rules may be created with respect to a recording of a selected media unit.

As may be appreciated, the various examples may be implemented differently based on, for example, a type of media unit (e.g., whether the media unit is television, movie, music, available immediately v. scheduled, etc.)

From the fifth friend user interface 750, user input indicating a selection of a back button 756 may be received. Upon receiving such a user input, the user may be presented with the fourth friend user interface 740 or may be presented with the third friend user interface 730 which may resume displaying of the first friend media event of the targeted friend highlight reel. The user may choose to continue watching the first friend media event on the third friend user interface 730 and, upon completion of the first friend media event, a second friend media event may automatically begin displaying on a sixth friend user interface 760. Alternately, upon receipt of the user input indicating selection of the back button on the fifth friend user interface 750, the sixth friend user interface 760 displaying the second friend media event may be automatically displayed.

The second friend media event displayed on the sixth friend user interface 760 is associated with a second relevant friend media unit (e.g., a piece of media consumed by Amy or Sue in the preceding week that was determined to be relevant). A second friend details icon 762 is displayed on the sixth friend user interface 760. Upon receiving an input indicating user selection of the second friend details icon 762, a friend user interface similar to fourth friend user interface 740, yet differing from fourth friend user interface 740 by presenting contextual metadata related to the second relevant friend media unit represented by the second friend media event. Similarly, a user may be able to navigate to a friend user interface similar to fifth friend user interface 750 yet differing from fifth friend user interface 750 by presenting, for example, an interactive schedule of media units related to the second relevant friend media unit as opposed to the first relevant friend media unit.

It may be appreciated that generation of a targeted friend highlight reel may occur in response to a user's request for the targeted friend highlight reel, as described in the example of FIG. 7. However, FIG. 7 is merely exemplary and it should be understood that the generation of a targeted friend highlight reel may occur in an absence of a request from a user for the targeted friend highlight reel, and/or at a predetermined schedule. That is, the targeted friend highlight reel may be generated and/or stored (e.g., at the media consumption aggregator) automatically at a predetermined schedule (e.g., once a day). In such a case, the targeted friend highlight reel may be simply retrieved (e.g., from a media consumption aggregator) and displayed. For example, the targeted friend highlight reel may be generated and sent to a user at a predetermined schedule. As one example, a targeted friend highlight reel may be sent to a user via e-mail, once a week, where the targeted friend highlight reel is generated based on media consumption data associated with one or more friend identifiers having strongest friend connection(s) to the user identifier in a social graph.

It is notable that the user interfaces of FIG. 7 are examples and are not meant to be limiting in any way. As discussed above, highlight reels may be created, controlled, delivered, presented, and/or viewed in any suitable way without departing from the scope of this disclosure. Various configurations and layouts of user interfaces for displaying menus, selectable options, media events, contextual metadata, and/or schedules are conceivable, and may include any of text, graphics, and/or sound.

The types of devices capable of implementing the system and methods described herein are not limited to the devices illustrated, and may include any of a television, set-top box, desktop computing device, laptop computing device, personal digital assistant (PDA), mobile phone, gaming computing device, etc.

It is noted that the systems, methods, and user interfaces illustrated herein are merely exemplary and not meant to be limiting. In some embodiments, the above described methods and processes may be tied to a computing system. As an example, FIG. 2 schematically shows a media consumption aggregator 202 (e.g., a computing system) that may perform one or more of the above described methods and processes. Media consumption aggregator 202 includes a logic subsystem 236 and a data-holding subsystem 232. Media consumption aggregator 202 may optionally include a display subsystem and/or other components not shown in FIG. 2.

Logic subsystem 236 may include one or more physical devices configured to execute one or more instructions. For example, the logic subsystem may be configured to execute one or more instructions that are part of one or more programs, routines, objects, components, data structures, or other logical constructs. Such instructions may be implemented to perform a task, implement a data type, transform the state of one or more devices, or otherwise arrive at a desired result. The logic subsystem 236 may include one or more processors that are configured to execute software instructions. Additionally or alternatively, the logic subsystem 236 may include one or more hardware or firmware logic machines configured to execute hardware or firmware instructions. The logic subsystem 236 may optionally include individual components that are distributed throughout two or more devices, which may be remotely located in some embodiments.

Data-holding subsystem 232 may include one or more physical, non-transitory, devices configured to hold data and/or instructions executable by the logic subsystem to implement the herein described methods and processes. When such methods and processes are implemented, the state of data-holding subsystem 232 may be transformed (e.g., to hold different data). Data-holding subsystem 232 may include removable media and/or built-in devices. Data-holding subsystem 232 may include optical memory devices, semiconductor memory devices, and/or magnetic memory devices, among others. Data-holding subsystem 232 may include devices with one or more of the following characteristics: volatile, nonvolatile, dynamic, static, read/write, read-only, random access, sequential access, location addressable, file addressable, and content addressable. In some embodiments, logic subsystem 236 and data-holding subsystem 232 may be integrated into one or more common devices, such as an application specific integrated circuit or a system on a chip.

Although not shown in FIG. 2, an aspect of the data-holding subsystem 232 may be in the form of computer-readable removable media, which may be used to store and/or transfer data and/or instructions executable to implement the herein described methods and processes.

The terms “module” and “engine” may be used to describe an aspect of media consumption aggregator 202 (e.g., computing system) that is implemented to perform one or more particular functions. In some cases, such a module or engine may be instantiated via logic subsystem 236 executing instructions held by data-holding subsystem 232. It is to be understood that different modules and/or engines may be instantiated from the same application, code block, object, routine, and/or function. Likewise, the same module and/or engine may be instantiated by different applications, code blocks, objects, routines, and/or functions in some cases.

When included, a display subsystem may be used to present a visual representation of data held by data-holding subsystem 232. As the herein described methods and processes change the data held by the data-holding subsystem 232, and thus transform the state of the data-holding subsystem 232, the state of the display subsystem may likewise be transformed to visually represent changes in the underlying data. Display subsystem may include one or more display devices utilizing virtually any type of technology. Such display devices may be combined with logic subsystem 236 and/or data-holding subsystem 232 in a shared enclosure, or such display devices may be peripheral display devices.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method for generating a personal highlight reel comprising:
receiving personal consumption data indicating one or more media units consumed by a user computing device,
storing the personal consumption data in association with a user identifier,
identifying one or more relevant personal media units based on the personal consumption data,
generating a personal highlight reel including one or more personal media events representative of the one or more relevant personal media units, and
outputting the personal highlight reel.

2. The method of claim 1, where the identifying includes identifying one or more media units that have been consumed in association with the user identifier a threshold number of times, consumed in association with the user identifier for a threshold duration, rated in association with the user identifier, or recommended in association with the user identifier.

3. The method of claim 1, where the one or more personal media events include one or more of a media trailer, a media synopsis, a popular media segment, and an editorially-identified media segment.

4. The method of claim 1, further comprising determining friend identifiers having a friend connection to the user identifier in a social graph.

5. The method of claim 4, where the outputting includes sending the personal highlight reel to at least one friend computing device associated with at least one of the friend identifiers.

6. The method of claim 4, further comprising:
receiving friend consumption data indicating one or more friend media units consumed by one or more friend computing devices in association with the friend identifiers,
identifying relevant community media units from the friend consumption data,
filtering the relevant community media units based on overlap between the relevant community media units and the one or more media units consumed by the user computing device to thereby generate filtered relevant community media units,
generating a community highlight reel including friend media events representative of the filtered relevant community media units, and
outputting the community highlight reel.

7. A method for generating a targeted friend highlight reel at a media consumption aggregator, including:
receiving friend consumption data indicating friend media units consumed in association with respective friend identifiers;
storing the friend consumption data in association with the respective friend identifiers;
identifying one or more relevant friend media units based on the friend consumption data of at least one of the friend identifiers;
generating a targeted friend highlight reel including friend media events representative of the one or more relevant friend media units; and
outputting the targeted friend highlight reel.

8. The method of claim 7, further comprising receiving a targeted friend highlight reel request specifying the at least one of the friend identifiers and, in response, carrying out the identifying, generating, and outputting.

9. The method of claim 7, further comprising receiving personal consumption data indicating media units consumed in association with a user identifier, where the generating of the targeted friend highlight reel includes excluding friend media events representative of relevant friend media units that overlap with media units consumed in association with the user identifier.

10. The method of claim 7, where the outputting of the targeted friend highlight reel includes outputting targeted contextual metadata specifying one or more of the friend identifiers associated with each of the friend media events.

11. The method of claim 7, where outputting of the targeted friend highlight reel includes outputting targeted contextual metadata including one or more of a consumption statistic, a rating, and a recommendation associated with each of the friend media events.

12. The method of claim 7, further comprising outputting an interactive schedule of upcoming events associated with the friend media events of the targeted friend highlight reel.

13. The method of claim 12, further comprising receiving a selected upcoming event of the interactive schedule and, in response, scheduling an appointment related to the selected upcoming event.

14. A method for generating a community highlight reel at a media consumption aggregator, comprising:
receiving personal consumption data indicating media units consumed by a user computing device;
determining friend identifiers associated with a user identifier based on a social graph of friend connections between the user identifier and each of the friend identifiers;
receiving friend consumption data indicating media units consumed by one or more friend computing devices;
storing the personal consumption data in association with the user identifier and the friend consumption data in association with respective friend identifiers;
identifying relevant community media units from the friend consumption data, based at least on a consumption frequency;
filtering the relevant community media units based on overlap between the relevant community media units and the media units consumed by the user computing device to thereby generate filtered relevant community media units;
compiling a community highlight reel including community media events representative of the filtered relevant community media units, outputting the community highlight reel for presentation.

15. The method of claim 14, further comprising receiving a request to schedule an appointment related to one of the community media events of the community highlight reel.

16. The method of claim 14, where the identifying of relevant community media units is based on one or more of a threshold number of times a particular media unit has been consumed in a time period and a threshold number of consumptions of the particular media unit in association with the friend identifiers.

17. The method of claim 14, where the identifying of relevant community media units is further based on a rating or a recommendation of a particular media unit in association with one or more of the friend identifiers.

18. The method of claim 14, wherein the community media events include one or more of a media trailer, a media synopsis, a popular media segment, and an editorially-identified media segment.

19. The method of claim 14, further comprising determining a strength of the friend connections between the user identifier and each of the friend identifiers, where the identifying of relevant community media units is further based on the strength of friend connections between the user identifier and each of the friend identifiers.

20. The method of claim 14, where the compiling includes linking community contextual metadata to each of the community media events, the community contextual metadata indicating one or more of the friend identifiers associated with each of the community media events and an amount of consumption of each of the filtered relevant community media unit in association with the one or more of the friend identifiers associated with each of the community media events.
